(19) United States
(12) Patent Application Publication
(10) Pub. No.: US 2025/0138632 A1
(43) Pub. Date: May 1, 2025

(54) SHARED THEMES FOR AVATARS IN VIRTUAL ENVIRONMENTS

(71) Applicant: International Business Machines Corporation, Armonk, NY (US)

(72) Inventors: Peng Hui Jiang, Beijing (CN); Jun Su, Beijing (CN); Guang Han Sui, Beijing (CN); Su Liu, Austin, TX (US); Yu Zhu, Beijing (CN)

(21) Appl. No.: 18/383,574

(22) Filed: Oct. 25, 2023

(51) Int. Cl. G06F 3/01; G06F 16/906; G06F 16/9536

(52) U.S. Cl. CPC G06F 3/015; G06F 16/906; G06F 16/9536

(57) ABSTRACT

Techniques are described with respect to a system, method, and computer program product for managing a virtual environment context. An associated method includes analyzing a plurality of avatars associated with the virtual environment; ranking each avatar of the plurality of avatars based on the analysis; grouping at least a subset of the avatars based on a scoring of each avatar associated with the ranking; and modifying the virtual environment for the subset in accordance with the virtual environment context based on the analysis.

### FIELD

The present invention relates to rendering and presentation of virtual, augmented, mixed, and/or extended reality environments. Specifically, the present invention relates generating and visualizing shared themes for avatars within virtual environments.

### BACKGROUND

Virtual, augmented, mixed, and extended reality experiences encompass a user immersing themselves fully in a virtualized environment, which allows the user to perform tasks such as interacting with other remote users over a network. The implication of these experiences lie in the ability for avatars representing users to be able to interact with each other in real-time. However, digital reality experience platforms have began to integrate cognitive technologies into the platforms resulting in a more personalized experience. In particular, sounds, media content, and other applicable sensations associated with the user are simulated and analyzed by providing a combination of real and virtual worlds along with features such as real-time interactions among users and digital objects. With the assistance of advanced VR/AR technologies along with artificial intelligence technologies, virtual environments may be rendered that reflect affinity of the avatars within them.

### SUMMARY

Additional aspects and/or advantages will be set forth in part in the description which follows and, in part, will be apparent from the description, or may be learned by practice of the invention.

Aspects of an embodiment of the present invention disclose a method, system, and computer program product for managing a virtual environment context. In some embodiments, the computer-implemented method for managing a virtual environment context comprises analyzing a plurality of avatars associated with the virtual environment; ranking each avatar of the plurality of avatars based on the analysis; grouping at least a subset of the avatars based on a scoring of each avatar associated with the ranking; and modifying the virtual environment for the subset in accordance with the virtual environment context based on the analysis.

In some aspects of an embodiment of the present invention, a virtual environment is generated based on the virtual environment context and an affinity associated with the subset, wherein the virtual environment comprises a theme shared among the avatars of the subset reflecting the affinity.

In some aspects of an embodiment of the present invention, analyzing the plurality of avatars comprises determining a sentiment of each avatar of the plurality of avatars and scoring a compatibility of each avatar with the plurality of avatars based on the sentiment. Grouping at least a subset of the avatars comprises determining an affinity associated with the subset based on the scoring; wherein the affinity is derived from an emotional analysis of each avatar in the subset.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual environment context management system environment, according to an exemplary embodiment;

FIG. 3 illustrates a block diagram of a virtual environment module and a grouping module of FIG. 2, according to an exemplary embodiment;

FIG. 4 illustrates a first virtual environment scene associated with a group of avatars, according to an exemplary embodiment;

FIG. 5 illustrates a second virtual environment scene depicting a shared theme ascertained from an affinity of the group of avatars of FIG. 4., according to an exemplary embodiment; and

FIG. 6 illustrates an exemplary flowchart depicting a method for managing a virtual environment context, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for managing a virtual environment context. Virtual, augmented, mixed, and extended reality (hereinafter “virtual reality”) experiences provide outputs that are detected by a user's vision, hearing, and other senses, in order to give the user the illusion of experiencing a real physical world, rather than simply seeing and/or hearing a representation of the physical world. In addition, these experiences provide computer-generated simulations that integrate real-world sensory input with overlaid computer-generated elements, such as sounds, videos, images, graphics, etc. allowing users to move around virtual environments, interact with other users via avatars (i.e., digital user representations) and otherwise experience shared virtual events (e.g., virtual concerts, E-Sports, etc.) from the user's perspective. Socializing among users within virtual environments increasingly gains popularity, in which users across various geographic locations are able to collaboratively engage with each other along with virtual elements (e.g., virtual objects, avatars, themes, etc.) of virtual environments. In particular, themes associated with virtual environments may be generated and/or ascertained, in which the virtual elements of a virtual environment are depicted in accordance with the theme. For example, if a virtual environment shared among users is a virtual concert then the virtual environment along with its virtual elements may reflect a virtual venue, themes, spectators, advertisements, and the like relevant to a virtual concert. Therefore, the present embodiments have the capacity to improve virtual reality by not only providing shared virtual experiences for users including a theme and/or context that reflects an affinity of users associated with the virtual environment, but also optimizing the virtual reality experience by allowing a theme and/or context of a virtual environment to be modified in real-time based on a detected change of the affinity of avatars in the virtual environment. In addition, dynamic modifications to shared themes within the virtual environment reduce the amount of computing resources necessary to render individualized virtual environments for respective computing devices, in which shared virtual themes support scalable virtual element libraries that serve as mechanisms for rendering themes for the virtual environments more efficiently. Thus, the theme and virtual objects of the virtual environment reflect the affinity of the users of the avatars associated within the virtual environment in a sustainable manner.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. In addition, VR refers to technology that enables enhancement of user perception of a real-world environment through superimposition of a digital overlay in a display interface providing a view of such environment. It should be noted that a VR environment may be provided by any applicable computing device(s) configured to support a VR, augmented reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, context refers to a theme, topic/subject, atmosphere, tone, ambiance, situation, locality, and any other applicable factor taken into account when rendering and visualizing virtual environments known to those of ordinary skill in the art. As described throughout, context can be ascertained by natural language processing (“NLP”), convolutional neural networks (“CNN”), linguistic input analysis, virtual environment/virtual object analysis, or any other virtual reality-based analysis mechanisms known to those of ordinary skill in the art.

As described herein, an “affinity” is a nexus among users in a virtual environment represented via avatars, in which the nexus is ascertained from one or more automated methods including, but not limited to predictor functions, machine-learned algorithms, or any other algorithms for determining affinities known to those of ordinary skill in the art. For example, an affinity may be based upon an ascertained sentiment consensus, social networking-based graphs (e.g., closeness of user 270 to other users), topics of interests shared among users, or any other applicable commonalities of a group that may be ascertained.

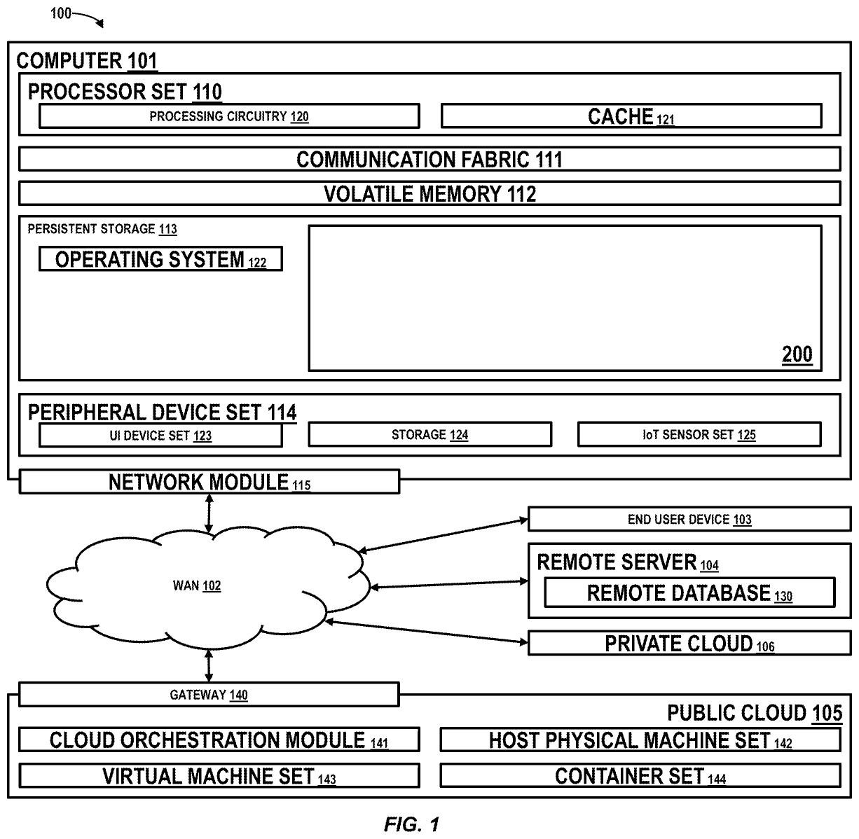

The following described exemplary embodiments provide a system, method, and computer program product for managing a virtual environment context. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

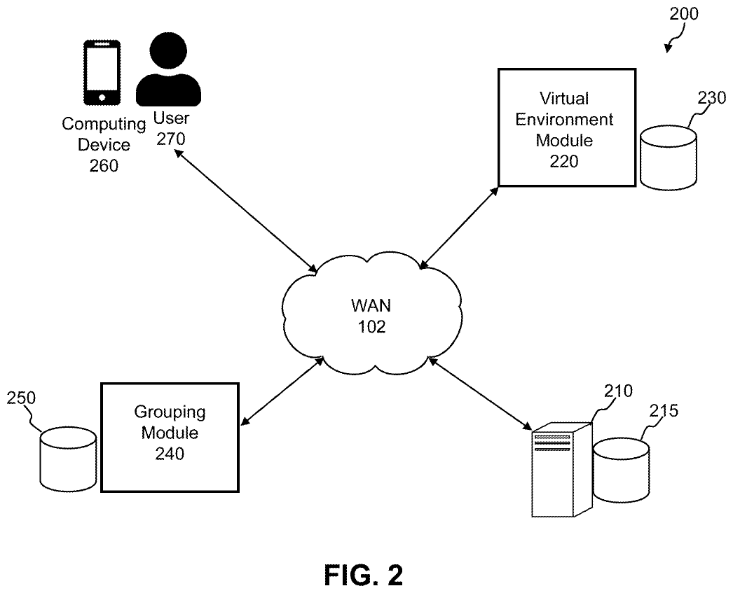

Referring now to FIG. 2, a functional block diagram of a networked computer environment illustrating a computing environment for managing a virtual environment context system 200 (hereinafter “system”) comprising a server 210 communicatively coupled to a database 215, a virtual environment module 220, a virtual environment analysis database 230, a grouping module 240, a grouping module database 250, and a computing device 260 associated with a user 270, each of which are communicatively coupled over WAN 102 (hereinafter “network”) and data from the components of system 200 transmitted across the network is stored in database 215. In some embodiments, server 210 is configured to operate a centralized platform serving as a cloud-based user grouping and VR context visualizing mechanism within VR environments. Server 210 is configured to provide a mechanism for user 270 to provide user inputs and establish preferences, privacy settings, and the like via accessing one or more user interfaces and application programming interfaces (APIs) provided to computing device 260.

In some embodiments, the centralized platform is configured to enable user 270 to not only view user groupings, grouping affinities, assigned contexts and themes, and the like; but also, designate preferences as to other preferred users to be grouped with and themes that are preferred to be associated with certain affinities. For example, user 270 may designate that when the affinity of a group associated with them indicates a sentiment of relaxation that the theme for the virtual environment will be a tranquil nature-based visualization (e.g., a running brook, a tropical rainforest, and the like). In another example, user 270 may designate on the centralized platform that when the group affinity indicates a sentiment of gloom that privacy settings are initiated that prevent the avatars of the group from being visible to one another despite being in the same virtual environment. It should be noted that various indicators associated with the individual emotions of users within a group that impact the scoring of users and/or ascertaining the affinity may be accounted for in real-time based on sentiments of user 270 in response to a current situation or happening. For example, trained machine learning models of virtual environment module 220 are utilized to identify the emotions or sentiments of avatars in the virtual environment (e.g., reactions such as applause, cheers, facial expressions, body gestures, and the like).

Virtual environment module 220 is configured to not only analyze virtual environments in order to ascertain an associated contexts, but also analyze the utterances, gestures, and other applicable interactions of users in order to visualize a shared theme of users that depicts a group affinity. Virtual environment module 220 is further tasked with visualizing the group affinity as a shared theme within the virtual environment. Virtual environment module 220 is designed to utilize artificial intelligence techniques such as but not limited to, natural language processing (NLP), linguistics analysis, image analysis, topic identification, virtual object recognition, setting/environment classification, and any other applicable artificial intelligence and/or cognitive-based techniques in order to analyze virtual environments and elements within and store analyses in virtual environment analysis database 230. Data derived from the analyses are transmitted to grouping module 240 in order for grouping module 240 to ascertain an affinity of a group associated with the virtual environment. As a result, virtual environment module 220 generates a visualized theme for the virtual environment based on the context associate with the affinity. Virtual environment module 220 is further tasked with providing techniques that facilitate automatic, reliable performance of a point cloud object-environment segmentation task in order to analyze virtual environments and their environments.

Grouping module 240 is tasked with not only analyzing user utterances, gestures, movements, facial expressions, and the like in order to ascertain a sentiment of user 270, but also performing grouping of users in the virtual environment based on scoring of users based on the aforementioned. In addition, grouping module 240 ascertains an affinity of a group allowing virtual environment module 220 to generate a theme for a virtual environment shared among avatars of a group. It should be noted that the scoring and ranking of users may be based on a variety of factors including, but not limited to compatibility of user 270 among the remaining users of a group, geographic proximity, shared interests, a specific sentiment of user 270 shared with others regarding a topic, and the like. In some embodiments, grouping module 240 performs analysis of user 270 via electromyography (EMG), which is a diagnostic and analysis technique for evaluating and recording electrical activity produced by muscle tissue sourced from computing device 260. Muscle tissue at rest is normally electrically inactive; however, electrical potentials appear when muscle tissue is contracted. Therefore, facial EMG can be used to analyze the activation of muscles located in the face. In particular, EMG may be utilized by grouping module 240 to not only ascertain patterns associated with facial reactions of user 270 to various scenarios, but also analytics regarding topics and contexts that receive significant reactions from user 270. It should be noted that sentiments of user 270 may also be ascertained from analysis of utterances, movements, gestures, and the like.

Grouping of avatars within a virtual environment may be performed based on the generated score for user 270 exceeding a threshold which is correlated to the ranking of user 270, in which if the calculated score of user 270 exceeds the threshold then user 270 is allocated to a group comprising avatars that scored similarly according to the factors that were taken into account when computing the score of user 270. Analyses, patterns, analytics, predictions, etc. of users, grouping threshold, and grouping analytics may be stored in grouping module database 250.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network, or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IoT”) sensors, or any other applicable type of sensors known to those of ordinary skill in the art.

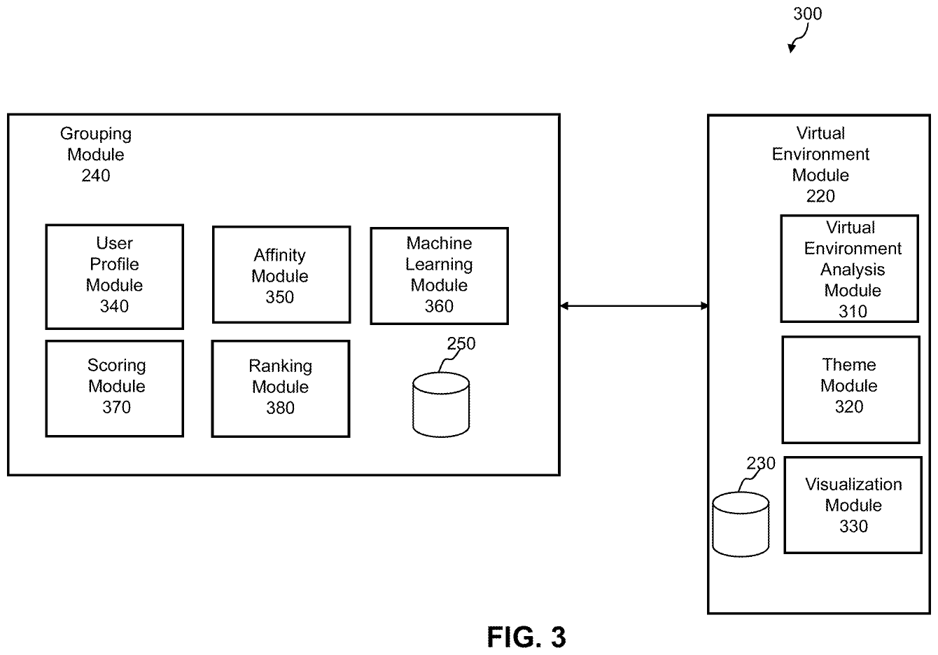

Referring now to FIG. 3, an example architecture 300 of virtual environment module 220 and grouping module 240 is depicted, according to an exemplary embodiment. Virtual environment module 220 comprises a virtual environment analysis module 310, a theme module 320, and a visualization module 330. Grouping allocation module 240 comprises a user profile module 340, an affinity module 350, a machine learning module 360, a scoring module 370, and a ranking module 380. The aforementioned modules are designed to be communicatively coupled allowing transmitting of applicable data over the network.

Virtual environment analysis module 310 is tasked with analyzing virtual environments in order to not only detect avatars and virtual elements, and ascertain context from components within virtual environments; but also taken into account factors associated with computing device 260 such as but not limited to physical surroundings (e.g., architectures, time periods/time of day, etc.), geographic location, linguistic inputs, speech patterns, gestures, and the like. Virtual environment analysis module 310 ascertains a context associated with a virtual environment based on analyses of the virtual environment. In some embodiments, movements of bodies and gestures occurring proximate to computing device 260 may allow virtual environment analysis module 310 to ascertain the context of the physical and/or virtual environment associated with user 270. For example, if user 270 is attending an E-Sport event and the fellow spectating avatars are jumping and cheering due to the excitement of the VR experience as opposed to user 270 who via EMG indicates that user 270 is not excited (e.g., their preferred team is losing), then based on the aforementioned virtual environment analysis module 310 is able to ascertain the context that user 270 is not pleased. As a result, this is taken into account when scoring module 370 is calculating the score for user 270 which determines the group that user 270 will be assigned to. It should be noted that virtual environment analysis module 310 may utilize image/video analysis, parsing, tokenizing, 3D point cloud segmentation, virtual object detection, theme identification, or any other applicable VR/AR-based analysis mechanisms known to those of ordinary skill in the art. In addition, virtual environment analysis module 310 may utilize natural language processing and other applicable cognitive-based techniques in order to process linguistic inputs of user 270 and others within proximity of computing device 260.

Theme module 320 is tasked with determining a theme for a virtual environment based on the context ascertained by virtual environment analysis module 310. In some embodiments, theme module 320 may utilize a knowledge graph in order to determine key themes and sentiments associated with the context. For example, the context may serve as a seed concept in which theme module 320 utilizes one or more algorithms to identify paths in the knowledge graph connecting seed concept(s) or trajectories that connect vectors representing the contexts, seed concepts, and themes in their embedding space. Continuing on the previous example, the ascertained context is user 270 disappointed at the E-Sport event that their preferred team is not winning, in which theme module 320 utilizes the aforementioned techniques to determine the concepts of frustration, disappointment, irritation, anxiety, etc. As a result, theme module 320 renders instructions for a virtual environment including a background/surrounding, virtual elements (e.g., virtual objects), avatars, etc. reflecting the concepts that visually match characteristics of the one or more of the theme, seed concept, context, and sentiments of user 270. In some embodiments, virtual environment analysis database 230 functions as a virtual object library comprising one or more data structures configured to store tags and other ascertainable information pertaining to the theme, seed concept, context, and sentiments of user 270. This allows more efficient rendering of the virtual environments by visualization module 330 by being able to retrieve virtual elements from virtual environment analysis database 230 in a scalable manner. It should be noted that the themes generated by theme module 320 are designed to be a shared theme for the avatars of the group (also referred to throughout as a “subset of users”) rendered in accordance with the affinity. For example, in the instance in which the virtual environment is the beginning of group virtual yoga session the virtual environment includes a group affinity of tranquility and peace based upon the avatars being in a moderately easy pose (i.e., mountain pose), in which the virtual environment depicts a natural river flowing from a mountain with a blue sky background free of clouds.

Visualization module 330 is tasked with rendering and visualizing the virtual environment to user 270 in addition to modifying a virtual environment based upon a detected change in context and/or group affinity. In some embodiments, visualization module 330 utilizes a utilized generative adversarial networks (GANs) and/or any other applicable VR/AR content mechanisms configured to support dynamic virtual content generation/modification, in which the rendering of virtual environments is influenced by the context and/or group affinity, including creating 3D scenes, applying lighting and shading effects, and generating textures to make the virtual environment look realistic. Furthermore, visualization module 330 renders the virtual elements for shared themes in a scalable and sustainable manner by referencing applicable virtual elements stored in a digital objects library included within virtual environment analysis database 230; thus, reducing the amount of computing resources necessary for visualization module 330 to render individualized virtual environments for respective computing devices that the shared themes are presented to. Traditionally, virtual elements associated with a theme are rendered in a manner in which a significant amount of computing resources are necessary in order to generate a virtual environment with a shared theme scalable for multiple users operating across a cloud-based platform. However, visualization module 330 is configured to communicate with server 210 to coordinate allocation and distribution of virtual resources necessary for generating the virtual environment including the shared theme on-demand by virtual environment analysis module 310 tagging virtual elements from previously rendered virtual environments, and storing the virtual elements in virtual environment analysis database 230. In some embodiments, the virtual elements are tagged with metadata derived from the context and/or theme of the applicable virtual environment allowing quick referencing when visualization module 330 is visualizing shared themes in subsequent virtual environments, in which the applicable metadata tag for a virtual element is taken into consideration during the scoring process described throughout.

Additionally, visualization module 330 is designed to facilitate transitions between virtual environments based on one or more of the context and the affinity of the group of avatars within the virtual environment. Continuing with the previous example of the group virtual yoga session, as the avatars transition into a more difficult yoga pose (i.e., tree pose) visualization module 330 begins to modify the virtual environment by transitioning clouds into the blue sky correlating to the changing group affinity indicating a more stressed sentiment among the avatars associated with more physical exertion required by the more difficult pose, or by changing the background of the virtual environment by darkening the surroundings with darker clouds. Amplification and/or increasing the size of virtual elements as the transition occurs is within the spirit of the disclosure. In addition, the transition between virtual environments may be applied in real-time based upon contextual factors taken into account associated with the avatars. For example, an avatar may utter “It looks like it's about to rain outside!”, in which virtual environment analysis module 310 utilizes linguistic input analysis to ascertain the context that it is raining outside initiating visualization module 330 to integrate dark clouds and rain into the modification to the virtual environment based on the context.

User profile module 340 is configured to generate a user profile associated with user 270 and other applicable users in the virtual environments. It should be noted that data associated with user 270 may be ascertained from various sources including, but not limited to applicable sensor data from computing device 260 (e.g., biological data, movement/gesture data, viewing analytics, etc.), social network profiles crawled by web crawlers associated with server 210, and the like, in which the user profiles are stored on grouping module database 250. For example, interests associated with user 270 may be derived from social network profile associated with user 270. User profiles may function as aggregations of user data associated with user 270 including, but not limited to, personal information, biological data, behavioral data, socio-demographic data, psychographic data, and the like continuously being updated via applicable data being received from one or more of server 210, computing device 260, and any other applicable data sources. In some embodiments, user profiles may be obtained from social media sources, resumes, etc. and users preferred for grouping with user 270 may be designated based on frequently interacted with contacts, nature of the relationship between user 270 and the particular user, amount of mutual social connections, and the like. One purpose of the user profiles is to serve as a source for user specific data associated with user 270 to be accounted for during the calculating of the score and subsequent ranking of user 270, in which taken into consideration when grouping avatars in a virtual environment. Social media characteristics may also be ascertained from social media sources by user profile module 340 analyzing and extracting Social media characteristics of users associated with the avatars.

Affinity module 350 is tasked with ascertaining an affinity of a group of users represented as avatars within a given virtual environment. In some embodiments, the affinity of a group is based on the aggregation of scores for users calculated by scoring module 370, in which the affinity represents a group consensus regarding one or more of a sentiment, interest, Personality Traits, Cultural and Social Factors, etc. towards a person, place, concept, context, environment, and the like. The affinity may be versatile as described herein due to the fact that it may be taken into consideration in light of the ascertained context in order for theme module 320 to establish the shared theme for a given virtual environment, or the affinity may be the basis for the transition from a first virtual environment to a second virtual environment for the group. In some embodiments, affinity module 350 generates index and distance metrics that account for similarity algorithms measured across features sets derived from one or more of database 215, virtual environment analysis database 230, grouping module database 250.

Machine learning module 360 is configured to use one or more heuristics and/or machine learning models for performing one or more of the various aspects as described herein. In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, Siamese network (“twin neural network”), long short-term memory (LSTM), convolutional neural network (CNN), generative adversarial network (GAN), recursive neural network (RNN), sequence-to-sequence model, shallow neural network, multilayer perceptron (MLP), back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 360 is configured to operate and maintain one or more machine learning models configured to utilized training datasets derived from database 215, virtual environment analysis database 230, grouping module database 250, and any other applicable data source, in which the one or more machine learning models are configured to generate outputs representing predictions of group affinities, user scorings/rankings, users groupings, and shared themes for the virtual environments. For example, if two users are a strong interest pertaining to a particular topic then in addition to their respective avatars being allocated to the same group they would also be integrated into a virtual environment that included a shared theme associated with said particular topic.

Scoring module 370 is designed to calculate a score for users that will ultimate be assigned to groups. It should be noted that scoring of users may take into consideration a plurality of factors for scoring including, but not limited to, user activities, user interests, the type/context of the virtual environments commonly frequented, the geographic location of users, social networking graphs, historical interactions among users, affinities of groups from previous affiliations, and the like. In some embodiments, scoring module 370 is configured to use one or more cognitive tools to perform dimensionality reduction and nearest neighbor technique to cluster hyperplane correlations of similar features, joint and individual, shared across ascertained contexts. In other embodiments, the scoring may be built up based on cohort analysis of the relationships of user 270 ascertained from the user profile. Scoring may also account for a threshold correlated to the ranking of each avatar of the group established by ranking module 380. For example, user 270 being assigned to a particular group may be determined based on their score exceeding the threshold. Although various scoring mechanisms are discussed throughout, the score assigned to the applicable user dictates the group that said user is assigned to in which each user in the group may express a sentiment relevant to an established context.

Ranking module 380 is tasked with ranking of users of groups. It should be noted that ranking of users may take into consideration one or more of a user's score, the ascertained context of a virtual environment, an aggregation of sentiments of users in a group manifested as the affinity, type of virtual environment, geographic location, level of interaction among users in a group, frequency of interactions between users and virtual elements (e.g., virtual assistants, virtual objects, prompts, etc.) of a virtual environment, and the like. For example, a scenario in which a group of users are participating in a collaborative virtual project within a shared virtual environment and attempting to ascertain a consensus regarding a particular topic of the collaborative project. Ranking module 380 evaluates and ranks each user based on various factors such as their individual scores, their level of interaction within the virtual environment, their frequency of engaging with virtual elements, and the sentiment aggregation that represents the group's affinity.

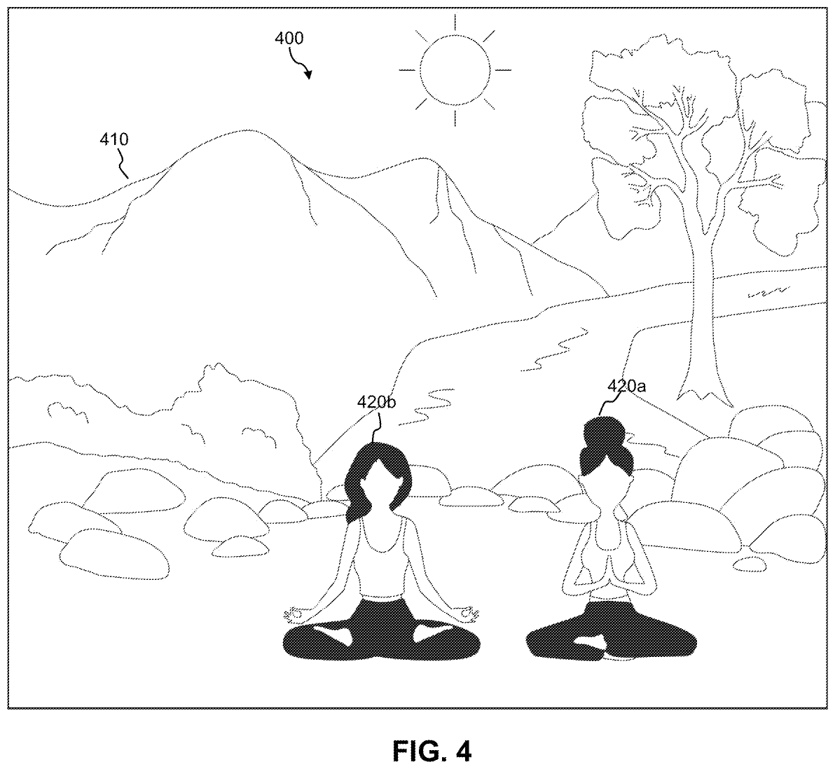

Referring to FIG. 4, a first virtual environment 400 is depicted, according to an exemplary embodiment. As illustrated, first virtual environment 400 comprises a tranquil setting 410 reflecting a first affinity of avatars 420a-b, which indicates a group consensus reflecting the sentiments of relaxation and peace. In some embodiments, electromyography is performed by the one or more machine learning models operated by machine learning module 360 on applicable sensor data received from computing device 260 (e.g., facial movements, etc.) allowing affinity module 350 to ascertain that the users associated with 420a-b are expressing sentiments indicating relaxation and peace; therefore, the affinity of the group is tranquil. As a result, grouping module 240 instructs virtual environment module 220 to render first virtual environment 400 comprising tranquil setting 410 to reflect the affinity. In some embodiments, virtual environment module 220 communicates with machine learning module 360 in order to utilize a GAN, such as CycleGan that includes a CNN layer. It should be noted that tranquil setting 410 may be modified via machine learning models operated by machine learning module 360 trained based on external stimulus of user 270 created based on user 270 interactions with one or more of avatars of the group, virtual elements of virtual environment 400, and the like. For example, avatars 420a-b interactions with a virtual element of virtual environment 400, such as a digital assistant, may in real-time provide guidance for avatars 420a-b depending upon the applicable context in which tranquil setting 410 may be modified based upon one or more of a detected change to the group affinity, scoring of applicable user, ranking of applicable user, context of virtual environment 400, and the like.

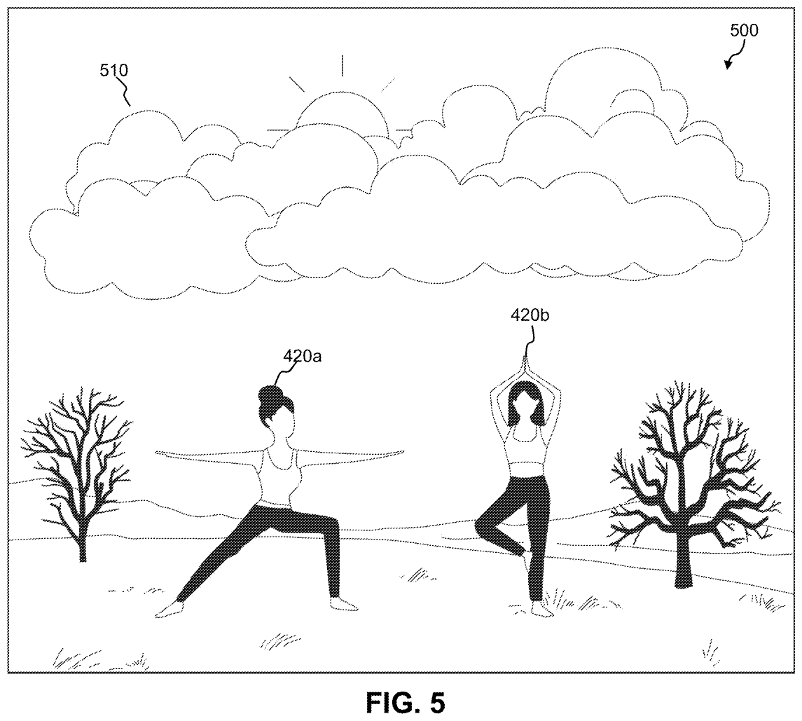

Referring to FIG. 5, a second virtual environment 500 is depicted, according to an exemplary embodiment. It should be noted that second virtual environment 500 illustrates one or more transitions from the first virtual environment in which the first virtual environment is modified based upon a detected change in the affinity among avatars 420a-b. In particular, second virtual environment 500 comprises an agitated setting 510 designed to reflect a consensus of sentiments of the users associated with avatars 420a-b indicating difficulty associated with maintaining their respective yoga poses. In some embodiments, transitions and/or modifications to the second virtual environment 500 are based on a change in the affinity of the group derived from an emotional analysis of avatars 420a-b performed by affinity module 350. Continuing on the previous example, the change in affinity of avatars 420a-b is based on the stress and strain associated with moving from easier yoga positions to harder yoga positions and this may be ascertained via EMG performed on the associated users that reveals a pattern of particular facial movements that indicate stress and/or strain. As a result, the modifications reflected in second virtual environment 500 are manifested as changes to the scenery (e.g., leaves falling off of tries, rivers drying up, clouds appearing, etc.); thus, representing transitions from the first virtual environment that correlate in real-time to changes of affinity of the group and/or current sentiments associated with avatars 420a-b.

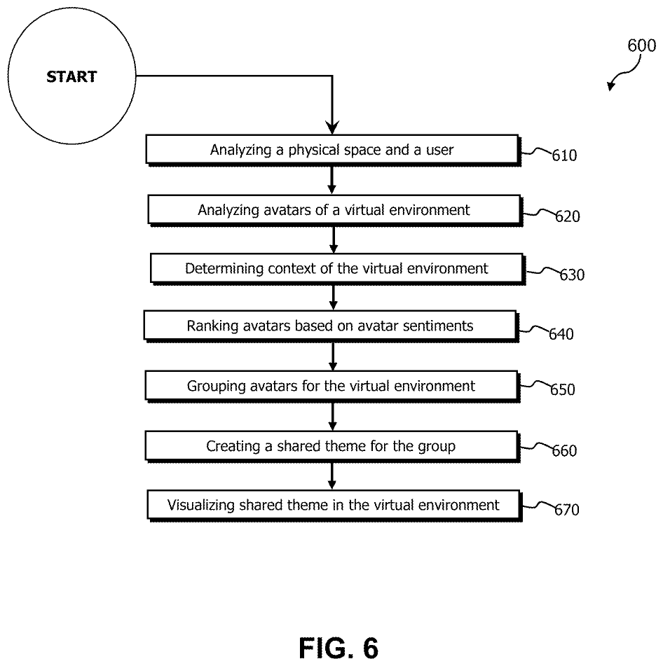

With the foregoing overview of the example architecture, it may be helpful now to consider a high-level discussion of an example process. FIG. 6 depicts a flowchart illustrating a computer-implemented process 600 for managing a virtual environment context, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment module 220 analyzes a physical space and grouping module 240 analyzes applicable data associated with user 270. Applicable data associated with the physical space and user 270 may be sourced from one or more sensors associated with computing device 260, a monitoring system, a computer visioning system, or any other applicable data sources relating to visualizing users and virtual environments known to those of ordinary skill in the art. It should be noted that virtual environments may require image/video analysis, parsing, tokenizing, 3D point cloud segmentation, virtual object detection, theme identification, or any other applicable VR/AR-based analysis mechanisms. Various types of data may be taken into account during analyses of the physical space and user 270 including, but not limited to biological data, movement data, LiDAR data, LADAR data, and the like.

At step 620 of process 600, grouping module 240 performs analysis of avatars. As previously discussed, electromyography may be utilized to ascertain sentiments of users manifested via the avatars; however, attributes of the avatars such as, but not limited to activity patterns, interactions with virtual elements of the virtual environment, gestures (e.g., body/limb movements, swiping, eye movements/gazing, etc.), and the like may be ascertained during the analyses of the avatars in order to determine sentiments. In some embodiments, the tone of user 270 can be ascertained and used in conjunction with facial expressions to determine the emotional state of user 270. For example, machine learning module 360 may be utilized to detect patterns of tones and facial movements, correlate derived sentiments with contexts.

At step 630 of process 600, virtual environment analysis module 310 determines the context of the virtual environment based on the analyses. Context may be ascertained from the dialogue, layouts/themes, and/or virtual elements integrated within the virtual environment such as, but not limited to, avatars, widgets, virtual objects, and any other applicable computer-generated objects and computer mediated reality incorporating visual, auditory, and other forms of sensory feedback. In some embodiments, context can be ascertained by natural language processing (“NLP”), convolutional neural networks (“CNN”), linguistic input analysis, virtual environment/virtual object analysis, or any other virtual reality-based analysis mechanisms known to those of ordinary skill in the art. It should be noted that the context is configured to direct what the purpose of the sentiment associated with user 270 is. For example, user 270 discussing a particular topic at a high volume would indicate that user 270 is angry and/or excited regarding the topic in light of the context.

At step 640 of process 600, ranking module 380 ranks the avatars based on one or more factors of the sentiment, context, group affinity, individual scores, interaction frequency, and even geographic location. These factors are considered and integrated to generate a ranking for each avatar, highlighting their active participation, contribution, and compatibility with the virtual environment's context. Through this ranking process, the module distinguishes avatars based on their engagement level, collaborative efforts, and alignment with the objectives of the virtual environment.

At step 650 of process 600, grouping module 240 groups avatars. It should be noted that the grouping of avatars may be based on one or more of calculated score for a user exceeding a threshold which is correlated to the ranking of user 270, in which if the calculated score of user 270 exceeds the threshold then user 270 is allocated to a group comprising avatars that scored similarly according to the factors that were taken into account when computing the score of user 270. It should be noted that groupings of avatars correlate to the avatars being grouped within a given virtual environment; however, grouping may also be allocated based on social network profiles, affinities, mutual interests of users, and the like.

At step 660 of process 600, theme module 320 creates a shared theme for the group. Theme module 320 renders the shared theme by utilizing virtual elements associated with the context, sentiments, affinity, and the like, which may be retrieved from a digital objects library included within virtual environment analysis database 230. For example, theme module 320 provides instructions for a virtual environment including a background/surrounding, virtual elements (e.g., virtual objects), avatars, etc. reflecting the concepts that visually match characteristics of the one or more of the theme, seed concept, context, and sentiments of user 270. The aforementioned may be generated by GANs and/or retrieved from previous renderings stored within virtual environment analysis database.

At step 670 of process 600, visualization module 330 visualizes the shared theme in the virtual environment. In addition to visualizing the virtual environment to user 270 on computing device 260, visualization module 330 provides modification of a virtual environment based upon a detected change in sentiments, context, and/or group affinity. In addition, visualization module 330 facilitates transitions in real-time between virtual environments based on one or more of the context and the affinity of the group of avatars within the virtual environment.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for managing a virtual environment context, the method comprising:
analyzing, by a computing device, a plurality of avatars associated with the virtual environment;
ranking, by the computing device, each avatar of the plurality of avatars based on the analysis;
grouping, by the computing device, at least a subset of the avatars based on a scoring of each avatar associated with the ranking; and
modifying, by the computing device, the virtual environment for the subset in accordance with the virtual environment context based on the analysis.

2. The computer-implemented method of claim 1, wherein analyzing the plurality of avatars comprises:
determining, by the computing device, a sentiment of each avatar of the plurality of avatars; and
scoring, by the computing device, a compatibility of each avatar with the plurality of avatars based on the sentiment.

3. The computer-implemented method of claim 1, wherein grouping at least the subset of the avatars comprises:
determining, by the computing device, an affinity associated with the subset based on the scoring;
wherein the affinity is derived from an emotional analysis of each avatar in the subset.

4. The computer-implemented method of claim 1, wherein the scoring comprises a threshold correlated to the ranking of each avatar of the plurality of avatars and the grouping is determined based on a score exceeding the threshold.

5. The computer-implemented method of claim 3, wherein modifying the virtual environment comprises:
transitioning, by the computing device, from a first virtual environment scene to a second virtual environment scene based on the analysis;
wherein the second virtual environment scene is rendered based on the affinity associated with the subset.

6. The computer-implemented method of claim 5, wherein the second virtual environment scene comprises a shared theme for the avatars of the subset in accordance with the affinity.

7. The computer-implemented method of claim 1, wherein analyzing the plurality of avatars comprises:
analyzing, by the computing device, a plurality of social media profiles of a plurality of users associated with the plurality of avatars; and
extracting, by the computing device, social media characteristics of the plurality of users from the plurality of social media profiles.

8. A computer program product for managing a virtual environment context, the computer program product comprising one or more computer readable storage media and program instructions collectively stored on the one or more computer readable storage media, the stored program instructions comprising:
program instructions to analyze a plurality of avatars associated with the virtual environment;
program instructions to rank each avatar of the plurality of avatars based on the analysis;
program instructions to group at least a subset of the avatars based on a scoring of each avatar associated with the ranking; and
program instructions to modify the virtual environment for the subset in accordance with the virtual environment context based on the analysis.

9. The computer program product of claim 8, wherein program instructions to analyze the plurality of avatars comprise:
program instructions to determine a sentiment of each avatar of the plurality of avatars; and
program instructions to score a compatibility of each avatar with the plurality of avatars based on the sentiment.

10. The computer program product of claim 8, wherein program instructions to group at least the subset of the avatars comprise:
program instructions determine an affinity associated with the subset based on the scoring;
wherein the affinity is derived from an emotional analysis of each avatar in the subset.

11. The computer program product of claim 8, wherein the scoring comprises a threshold correlated to the ranking of each avatar of the plurality of avatars and the grouping is determined based on a score exceeding the threshold.

12. The computer program product of claim 10, wherein program instructions to modify the virtual environment comprises:
program instructions to transition from a first virtual environment scene to a second virtual environment scene based on the analysis;
wherein the second virtual environment scene is rendered based on the affinity associated with the subset.

13. The computer program product of claim 12, wherein the second virtual environment scene comprises a shared theme for the avatars of the subset in accordance with the affinity.

14. The computer program product of claim 8, wherein program instructions to analyze the plurality of avatars comprise:
program instructions to analyze a plurality of social media profiles of a plurality of users associated with the plurality of avatars; and
program instructions to extract social media characteristics of the plurality of users from the plurality of social media profiles.

15. A computer system for managing a virtual environment context, the computer system comprising:
one or more processors;
one or more computer-readable memories;
program instructions stored on at least one of the one or more computer-readable memories for execution by at least one of the one or more processors, the program instructions comprising:
program instructions to analyze a plurality of avatars associated with the virtual environment;
program instructions to rank each avatar of the plurality of avatars based on the analysis;
program instructions to group at least a subset of the avatars based on a scoring of each avatar associated with the ranking; and
program instructions to modify the virtual environment for the subset in accordance with the virtual environment context based on the analysis.

16. The computer system of claim 15, wherein program instructions to analyze the plurality of avatars comprise:
program instructions to determine a sentiment of each avatar of the plurality of avatars; and
program instructions to score a compatibility of each avatar with the plurality of avatars based on the sentiment.

17. The computer system of claim 15, wherein program instructions to group at least the subset of the avatars comprise:
program instructions determine an affinity associated with the subset based on the scoring;
wherein the affinity is derived from an emotional analysis of each avatar in the subset.

18. The computer system of claim 15, wherein the scoring comprises a threshold correlated to the ranking of each avatar of the plurality of avatars and the grouping is determined based on a score exceeding the threshold.

19. The computer system of claim 17, wherein program instructions to modify the virtual environment comprises:
program instructions to transition from a first virtual environment scene to a second virtual environment scene based on the analysis;
wherein the second virtual environment scene is rendered based on the affinity associated with the subset.

20. The computer system of claim 15, wherein program instructions to analyze the plurality of avatars comprise:
program instructions to analyze a plurality of social media profiles of a plurality of users associated with the plurality of avatars; and
program instructions to extract social media characteristics of the plurality of users from the plurality of social media profiles.
